(19) United States
(12) Patent Application Publication
(10) Pub. No.: US 2005/0079102 A1
(43) Pub. Date: Apr. 14, 2005

(54) Interrogation apparatus

(76) Inventors: Kenneth L. Staton, San Carlos, CA (US); Vibhu Vivek, Santa Clara, CA (US); Tariq Nadeem Faiz, Hockessin, DE (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/684,753

(22) Filed: Oct. 14, 2003

(51) Int. Cl. G01N 21/00

(52) U.S. Cl. 422/82.05

(57) ABSTRACT

Apparatus and methods are disclosed involving a linear actuator motor such as a voice coil motor, including a driver for the motor, powered by a power supply. A failure of one or more of the power outputs of the power supply used by the linear actuator motor and the driver is determined. Alternatively, or in addition thereto, energy in the linear actuator motor outside a predetermined range is determined. The power supply or the power supply outputs are caused to shut down based on the failure of the power outputs and/or energy determined in the linear actuator motor.

### BACKGROUND OF THE INVENTION

This invention relates, for example, to apparatus for processing samples. More particularly, the present invention relates to automated apparatus and methods for interrogating the surface of a substrate comprising a plurality of individual features and, more specifically, to the protection against damage, such as thermal damage, to electrical devices associated with components of an interrogation apparatus. The invention has particular application to apparatus for analyzing the results of hybridization reactions involving nucleic acids.

Determining the nucleotide sequences and expression levels of nucleic acids (DNA and RNA) is critical to understanding the function and control of genes and their relationship, for example, to disease discovery and disease management. Analysis of genetic information plays a crucial role in biological experimentation. This has become especially true with regard to studies directed at understanding the fundamental genetic and environmental factors associated with disease and the effects of potential therapeutic agents on the cell. Such a determination permits the early detection of infectious organisms such as bacteria, viruses, etc.; genetic diseases such as sickle cell anemia; and various cancers. This paradigm shift has lead to an increasing need within the life science industries for more sensitive, more accurate and higher-throughput technologies for performing analysis on genetic material obtained from a variety of biological sources.

Unique or polymorphic nucleotide sequences in a polynucleotide can be detected by hybridization with an oligonucleotide probe. Hybridization is based on complementary base pairing. When complementary single stranded nucleic acids are incubated together, the complementary base sequences pair to form double stranded hybrid molecules. These techniques rely upon the inherent ability of nucleic acids to form duplexes via hydrogen bonding according to Watson-Crick base-pairing rules. The ability of single stranded deoxyribonucleic acid (ssDNA) or ribonucleic acid (RNA) to form a hydrogen bonded structure with a complementary nucleic acid sequence has been employed as an analytical tool in molecular biology research. An oligonucleotide probe employed in the detection is selected with a nucleotide sequence complementary, usually exactly complementary, to the nucleotide sequence in the target nucleic acid. Following hybridization of the probe with the target nucleic acid, any oligonucleotide probe/nucleic acid hybrids that have formed are typically separated from unhybridized probe. The amount of oligonucleotide probe in either of the two separated media is then tested to provide a qualitative or quantitative measurement of the amount of target nucleic acid originally present. In surface-bound DNA arrays, this separation is typically accomplished by washing the unbound and non-specifically bound material away from the array surface. The resulting wash protocol is normally optimized to the specific requirements of the assay, the probe type, the surface selected and other considerations. The surface is then scanned for the presence of the target.

Direct detection of labeled target nucleic acid hybridized to surface-bound polynucleotide probes is particularly advantageous if the surface contains a mosaic of different probes that are individually localized to discrete, known areas of the surface. Such ordered arrays containing a large number of oligonucleotide probes have been developed as tools for high throughput analyses of genotype and gene expression. Oligonucleotides synthesized on a solid support recognize uniquely complementary nucleic acids by hybridization, and arrays can be designed to define specific target sequences, analyze gene expression patterns or identify specific allelic variations. The arrays may be microarrays created by in-situ synthesis or oligonucleotide deposition. Microarrays created by cDNA deposition are used to analyze gene expression patterns and perform genome scanning. Protein arrays are very useful for determining the presence and quantity of specific proteins in a cell or tissue.

In one approach, cell matter is lysed, to release its DNA, mRNA or protein, which is then separated out by electrophoresis or other means and amplified, if necessary, and then tagged with a fluorescent or other label. The resulting mix is exposed to an array of oligonucleotide, cDNA, aptamer or protein probes, whereupon selective binding to matching probe sites takes place. The array is then washed and interrogated to determine the extent of hybridization reactions. In one approach the array is imaged so as to reveal for analysis and interpretation the sites where binding has occurred.

Biological assays involving fluorescently labeled molecules or scattering structures to detect, quantify or identify target chemical species bound to surfaces often use optical detection and imaging systems. Arrays of different chemical probe species provide methods of highly parallel detection, and hence improved speed and efficiency, in assays. These arrays are, for example, DNA arrays and protein matrix arrays, which need to be scanned to measure the number densities of labeled molecules and hence the concentration of target or probe molecules in solution. This sensing process often is accomplished by means of a fluorescence imaging system. Chemiluminescence and radioisotopes are alternative methods commonly employed.

In the use of substrates to which biopolymers such as polynucleotides are attached, a reader such as, e.g., an array reader, often is used to examine the surface of a substrate for the presence and amount of signal after a reaction has taken place. The interrogation device may be a scanning device involving an optical system. In common optical analysis techniques, a tightly focused or pinpoint laser beam scans the surface of the support in order to excite labels such as fluorophores, which may be present on the surface of the support. For fluorescent label molecules, the laser beam excites the labels. Then, fluorescent emissions from the fluorophores are analyzed by means of an optical measuring device. In a particular embodiment, a substrate housing is inserted into a reader, such as a laser scanner, which has a suitable mounting means for receiving and releasably retaining the holder in a known position. The scanner is able to read the location and intensity of signal such as fluorescence at each feature of an array following exposure to a fluorescently labeled sample such as a polynucleotide-containing sample. For example, such a scanner may be similar to the G2500 GeneArray Scanner or Agilent G2505 Scanner both available from Agilent Technologies, Inc., Palo Alto, Calif. Results from the interrogation can be processed such as by rejecting a reading for a feature which is below a predetermined threshold and/or forming conclusions based on the pattern read from the array such as whether or not a particular target sequence may have been present in the sample.

The interrogating apparatus typically comprises a number of electrical devices that provide for movement of components of an interrogating apparatus. Such electrical devices include, by way of illustration and not limitation, one or more of power supply, voice coil motor, voice coil driver, high power circuitry, and so forth. Voice coil motors are employed to provide for movement of interrogating lenses, holders for the substrate, focusing and so forth.

The peak current required by the voice coil motors in the interrogation apparatus exceeds the continuous current that the voice coil motor and the voice coil driver can sustain without damage. Currently, software is employed to control damage to these components. However, if one of the power supply outputs that provides current to the voice coil motors fails, the driver circuit will provide the maximum current from the other power supply output. This condition violates the damage-free operating area of the voice coil driver and the continuous power rating of the voice coil motor.

There is a continuing need for methods and apparatus particularly applicable to interrogation devices such as scanners for interrogating the surface of a substrate comprising a plurality of features such as, for example, an array of features on the substrate. It would be desirable to have methods and apparatus that address power supply failure with respect to electrical devices, such as voice coil motors and voice coil drivers, associated with components of an interrogation apparatus.

### SUMMARY OF THE INVENTION

One embodiment of the present invention is an apparatus for interrogating the surface of a substrate comprising a plurality of features. The apparatus comprises a source of light, a holder for a substrate, a linear actuator motor, such as a voice coil motor, and a driver for the motor, which moves the holder with respect to the source of light, a power supply for the linear actuator motor and the driver, and circuitry that disables one or more outputs of the power supply. Such circuitry may comprise sense circuitry for detecting failure of power outputs of the power supply and/or sense circuitry for detecting energy at the voice coil motor. In addition, such circuitry may comprise circuitry to disable one or more or all of the outputs of the power supply. The above apparatus may also comprise a linear actuator motor and a driver for moving the source of light with respect to the holder. In one embodiment, the sense circuitry resides at the driver.

Another embodiment of the present invention is a method for reducing damage to components in a linear actuator motor and a linear actuator driver powered by a power supply. To this end, one or more of the power outputs of the power supply is disabled. A failure of one or more of the power outputs of the power supply used by the linear actuator motor and its driver is determined. Alternatively, or in addition thereto, energy in the linear actuator motor outside a predetermined range is determined. The power supply itself, i.e., all of the power supply outputs, or less than all of the power supply outputs are caused to shut down based on the failure of the power outputs and/or energy determined in the linear actuator motor. Damage to the electrical devices is thereby reduced or avoided.

Another embodiment of the present invention is a method for reducing thermal damage to electrical devices associated with moving two or more components relative to one another wherein the electrical devices comprise a motor and a driver and are powered by a power supply. The power outputs of the power supply used by the electrical devices and/or the current at the motor are sensed. A determination is made as to whether one or more of the power outputs sensed in (a) are outside, for example, below, a predetermined range and/or whether the current at the motor sensed in (a) is outside, for example, above, a predetermined level. The power supply itself or one or more of the power supply outputs are shut down if one or more of the power outputs are outside the predetermined range and/or the current at the motor is outside a predetermined range and/or the current at the driver is outside a predetermined range. Damage to the electrical devices is thereby reduced or avoided.

In a particular aspect of the above embodiment, the components comprise a voice coil motor and a voice coil driver. The power outputs of the power supply used by the voice coil motor and the voice coil driver are sensed. A determination is made as to whether one or more of the power outputs sensed are below a predetermined value. If one or more of the power outputs are below the predetermined value, certain predetermined power outputs of the power supply are shut down or all of the power outputs are shut down.

In another particular aspect of the above method, the components comprise a voice coil motor and a voice coil driver. Current is sensed at the voice coil motor and/or the voice coil driver and a determination is made as to whether the current sensed is above a predetermined value. The power supply itself or some of the power outputs are shut down if the current is above the predetermined value.

Another embodiment of the present invention is a method for reducing damage such as thermal damage to a voice coil motor, and/or a voice coil driver, powered by a power supply. The method comprises inactivating the power supply by sensing a failure of one or more power outputs of the power supply. Damage to the electrical devices is thereby reduced or avoided.

Another embodiment of the present invention is a method for reducing damage such as thermal damage to a voice coil motor, and/or a voice coil driver, powered by a power supply. The method comprises inactivating the power supply by sensing an energy level at the voice coil driver above a predetermined level. Damage to the electrical devices is thereby reduced or avoided.

### BRIEF DESCRIPTION OF THE DRAWINGS

FIG. 1 is a flow chart depicting a method in accordance with the present invention.

FIG. 2 is a perspective view of a substrate bearing multiple arrays.

FIG. 3 is an enlarged view of a portion of FIG. 2 showing some of the identifiable individual regions (or “features”) of a single array of FIG. 2.

FIG. 4 is an enlarged cross-section of a portion of FIG. 3.

FIG. 5 is a diagrammatic sketch depicting an apparatus in accordance with the present invention.

### DETAILED DESCRIPTION OF SPECIFIC EMBODIMENTS

The present apparatus provides for interrogating the surface of a substrate comprising a plurality of features. The apparatus comprises a source of light, a holder for a substrate, a linear actuator motor and a driver for moving the holder with respect to the source of light, a power supply for the linear actuator motor and driver, and circuitry for sensing and disabling power outputs of the power supply. The circuitry may sense and disable all of the power outputs of the power supply thereby disabling the power supply itself. Alternatively, the circuitry may sense and disable only selected predetermined power outputs of the power supply. The circuitry may comprise sense circuitry for detecting failure of power outputs of the power supply and/or sense circuitry for detecting energy at the linear actuator motor. The above apparatus may also comprise a linear actuator motor such as, e.g., a voice coil motor, and a driver for the linear actuator motor such as, e.g., a voice coil driver, for moving the source of light with respect to the holder. In one embodiment, the sense circuitry resides at the driver.

Embodiments of the present methods and apparatus may provide protection against damage to electrical devices and, in particular, those associated with components of an apparatus that are moved relative to one another. The components that are moved relative to one another include, for example, stages that are moved in one, two or three directions, and so forth. In particular, the present methods avoid the destructive result of the failure of a power supply that provides outputs to the aforementioned electrical devices. Electrical devices are associated with the components, either separately or in cooperation, usually by electrical linkage, and provide the power for moving the components. The electrical devices include any actuator whose peak current needs to be greater than its continuous current rating regardless of whether the aforementioned motion is relative to another motion in the instrument, and include, for example, power supplies, linear actuator motors, linear actuator drivers, solenoids, and so forth. For example, linear actuators such as, for example, voice coil motors, with appropriate drivers are commonly used for generating moving forces for stages that comprise holders for substrates, light sources, mirrors, and the like. The voice coil motors receive power outputs from a power supply and are driven by voice coil drivers.

In embodiments of the present invention, a condition that warrants shut down of all of the power supply outputs, or shut down of a selected number of power supply outputs, to protect the electrical devices from damage such as thermal damage is sensed. One such condition is failure of the power supply, which may be determined by sensing the power outputs from the power supply to determine whether the power outputs fall outside a predetermined range or tolerance and/or by sensing the energy of the linear actuator motor to determine whether the energy falls outside a predetermined range or tolerance. The approach of the invention employs features of the power supply and/or the linear actuator driver to shut down the power supply when one of the above conditions is detected.

The power from the power outputs may be sensed in a number of ways. Usually, means for sensing the power outputs from the power supply include a controller such as a microcontroller and suitable software. Generally, a microcontroller is employed having analog inputs. The predetermined range for the power outputs is usually the power output tolerances. If the sensed value is outside, i.e., above or below, the predetermined range, one or more or all of the power supply outputs are disabled or inactivated. In this way irreparable damage to electrical components may be avoided. Usually, the value that is sensed is a value below the predetermined range. The predetermined range for the power outputs is dependent on the nature of the power supply, and so forth. For an interrogating device the power supply converts AC power into 1, 2, 3, 4, 5 or more different DC power outputs. The tolerances for the power outputs for such a device are usually in the range of about +10% to about −10%. In accordance with the present invention, if the sensed power outputs are outside of the above range, usually, below the above range, one or more or all of the outputs of the power supply are shut down. It should be noted that the above tolerances may differ depending on a specific configuration of components. However, the principles of the present invention may be applied and appropriate ranges used for determining the above may be ascertained with the above teaching in mind.

Failures other than the power supply may be determined by sensing the energy at the linear actuator motor. This may be done alternatively to or in conjunction with the sensing of the voltage output from the power supply. Usually, current at the linear actuator motor is sensed. Means for sensing the energy of the voice coil motor include device for measuring the current in the coil, device for measuring the current supplied to the coil driver circuit, and the like. The predetermined range for the energy of the linear actuator motor is usually the energy tolerances. If the sensed value is outside, i.e., above or below, the predetermined range, the power supply is inactivated. Usually, the value that is sensed is a value above the predetermined range. The predetermined range for the energy of the voice coil motor is dependent on the nature of the voice coil motor, and so forth. For an interrogating device the tolerances for the energy or current for a linear actuator motor for such a device are usually determined by conditions that would seldom, if ever, occur in normal operation, e.g., sustained current above about 50% of the peak current. In accordance with the present invention, if the sensed energy is outside of the above range, usually, greater than about 50%, one or more or all of the power supply outputs are caused to shut down.

In one approach the failure of the power outputs and/or the energy of the linear actuator motor is determined by sense circuitry residing at the linear actuator driver. It is, however, within the scope of the present invention to have the sense circuitry reside at other locations such as, for example, at the power supply, or on any other existing circuit board that connects the power supply outputs to the driver circuit, and so forth. In the situation where the sense circuitry resides at the power supply, monitoring the energy of the linear actuator motor is less convenient because additional cabling is necessary.

The sense circuitry resides at a particular location by virtue of being physically located at or near that location. This means that the printed circuit board is mounted at that location.

The sense circuitry may be an independent microcontroller with an analog to digital converter and active or passive signal conditioning, filtering, scaling and level shifting circuitry. An example, by way of illustration and not limitation, of suitable sense circuitry includes a microcontroller and A/D block.

In one embodiment the sense circuitry comprises means to determine if the sense circuitry is connected to disable circuitry of the power supply. Such means generally is only needed with a normally on power supply (control is a disable). The control circuit is typically an opto-isolator with the control function provided by driving an LED. An analog input on a microcontroller can measure the forward voltage drop of this LED to determine if the sense circuit is connected to the disable circuit. An example, by way of illustration and not limitation, of a suitable means includes a microcontroller, Ain, Dio, LED and resistors.

The disable circuitry is typically a standard feature built into a switching power supply and is therefore a function of the power supply. The relevant part of the circuit is an opto-isolator. Such power supplies are readily available.

The disable circuit in a switching power supply is available normally-on or normally-off. The latter is preferred since it will be obvious if there is no connection with the normally-off type. If, however, a normally-on type of disable circuit is employed, the means for determining if the sense circuitry is connected to disable circuitry of,the power supply may determine the supply voltage less the forward drop across an LED of the disable circuitry. This feature is useful for installation to provide an indication that things are correctly connected. If there is no connection, there is no protection.

In one embodiment the sense circuitry comprises means for indicating inability of the sense circuitry to function. Such means may be, for example, components for routing an enable signal (used by the scanner to turn on the linear actuator driver) through the microcontroller that implements the coil protection. If the microcontroller fails to detect the power supply disable circuit, it does not pass the enable signal to the linear actuator driver. This indicates lack of coil protection by the circuit not driving the coil.

In one approach means for indicating inability of the sense circuitry to function intercepts an enable signal for the driver. This may be accomplished by routing (passing) the enable signal through the microprocessor that implements the power supply monitor circuit. If the processor that drives the enable is unable to control the motor after it has enabled, then the driver has been disabled by the power supply monitor circuit.

As mentioned above, if a condition that warrants shut down of the power supply to protect the electrical devices from thermal destruction is sensed, the power supply is inactivated such as by causing all of the power supply outputs to shut down thereby inactivating or disabling the power supply. In one approach a power supply disable signal is employed to cause the power supply to shut down entirely or to shut down the power outputs. A suitable power supply disable signal employment for the above operation may be any circuit capable of sourcing or sinking the current for the LED in the power supplies opto-isolated enable/disable circuit. The current source or sink depends on the configuration of the LED, i.e., open anode or cathode.

As mentioned above, the present invention has particular application to an interrogation apparatus for interrogating the surface of a substrate comprising a plurality of features. Such an interrogation apparatus comprises a source of light, a holder for a substrate, a linear actuator motor and a linear actuator driver for moving the holder with respect to the source of light, optionally, a power supply for the linear actuator motor and linear actuator driver, sense circuitry for detecting failure of power outputs of the power supply and/or sense circuitry residing for detecting energy at the voice coil motor, disabling circuitry for disabling one or more or all of the power supply outputs, and so forth. In one embodiment the apparatus further comprises a linear actuator motor and a linear actuator driver for moving the source of light with respect to the holder.

The source of light provides means for illuminating the substrate to allow for interrogation of the surface of the substrate by, for example, a camera to image the substrate. Means for illuminating the substrate may comprise one or more light sources. The light source should be positioned such that the surface may be imaged for the desired qualities of the features such as size, shape, and position. Lighting can be directed to the surface of the substrate in a downward, upward, or lateral manner. Light may illuminate the surface of the substrate from the back of the substrate in which case the substrate must be optically transparent for the light to be transmitted therethrough. Glass, polycarbonate and other transparent materials are suitable as substrate materials if lighting is provided from the back for the substrate. A mentioned above, one suitable source of light is a laser. Lasers are well-known in the art and will not be discussed in detail herein.

The holder for the substrate may be any convenient element for receiving and retaining the substrate for interrogation. The holder may be a platform that is part of a stage, whose movement is influenced by a voice coil motor. The holder may in one embodiment have a body with side portions and clamps for holding a substrate on the holder.

The interrogation apparatus also comprises a linear actuator motor and a linear actuator driver for moving the substrate holder with respect to the source of light. The linear actuator motor is protected in accordance with the present invention. The linear actuator motor may be any motor that actuates linearly. Typical linear actuator motors include, for example, voice coil motors and the like. The linear actuator drivers for the linear actuator motors include, for example, linear power amplifiers, pulse width modulated power switches, and the like. Typical power supplies for the linear actuator motors and the linear actuator drivers include, for example, linear or switching AC to DC supplies, and so forth. Linear supplies lack a logic control signal to disable the outputs.

In one embodiment of the present invention the power supply is switched or disconnected at the driver circuit as opposed to switching (disabling) the power supply itself. The power supply may be switched at the driver circuit by disabling the appropriate power supply outputs to the driver circuit. Accordingly, appropriate sense circuitry and disabling circuitry is selected to achieve disabling of the predetermined or pre-selected outputs of the power supply. This embodiment has the advantage of allowing the controlling computer to display a meaningful error message to the user. It has the disadvantage of protecting fewer components from failure since a failure of one of the two monitored, but unswitched supplies (+18V and −18V) will result in protecting the coil and the driver (by switching off their source of power) with the possible destruction of components that derived power from the 18V supplies. The power switching in this embodiment of the invention is accomplished with, for example, pass transistors and the like. Mechanical relay contacts are not preferred because of damage by the in-rush current that charges the bulk bypass capacitance with normally open circuits. Normally closed circuits have the same problem during capacitor discharge when a supply is shorted.

In one aspect of the above embodiment a pass transistor switching scheme is employed, which uses power FET's that switch the two power supply outputs that power the voice coil. Instead of the logic output from the microcontroller driving the disable input of the power supply, the same logic output controls two FET switches. As mentioned above, this has the advantage of not turning off the embedded computer that controls the instrument, so that it is possible for the user interface software running on the host computer to report error status information to the operator.

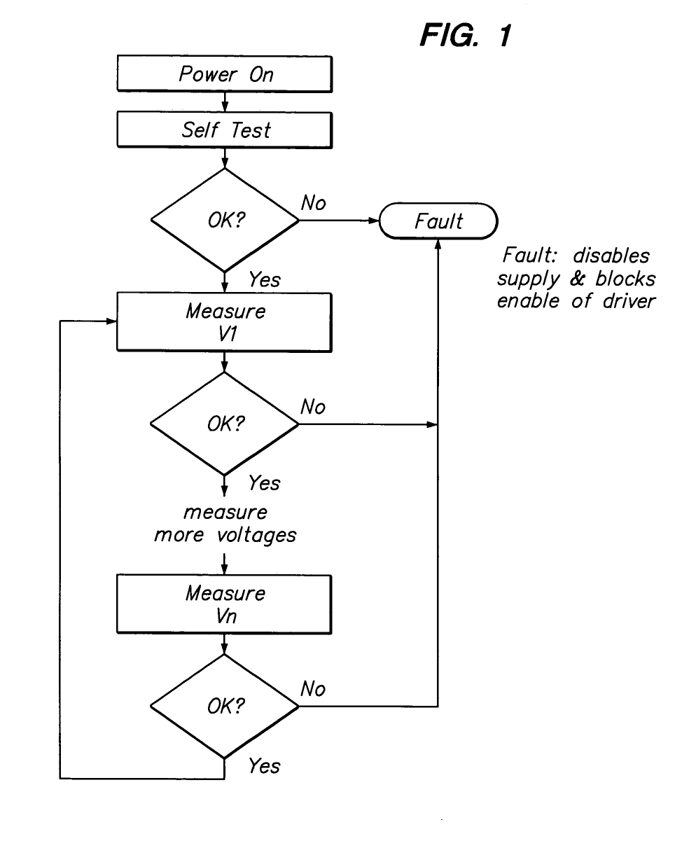

One embodiment of the invention is represented in the flow chart in FIG. 1. Referring to FIG. 1, the power supply is activated by turning on power. A self test is performed and the system either is okay (OK?) or not okay. If not okay (N), the power supply is disabled (Fault) and driver enable is blocked. If okay (Y), a voltage V1 is measured (Measure V1) and the system again is either okay (OK?) or not okay. If not okay (N), then, the power supply is disabled (Fault) and driver enable is blocked. If okay, more voltages are measured up to the n^{th} voltage (Measure Vn) and the system again is either okay (OK?) or not okay. If not okay (N), the power supply is disabled (Fault) and driver enable is blocked. If okay (Y), the circuitry begins another cycle beginning with measurement of a voltage V1 (Measure V1) and the system again is either okay (OK?) or not okay. The cycles are repeated to continuously monitor the system for failure.

The present apparatus comprises underlying embedded control systems that activate and animate the mechanical and electrical components of the apparatus of the invention causing them to manipulate substrate holders, light sources, optical components, and the like. The underlying embedded control systems comprise a collection of electronic circuitry, one or more embedded microprocessors (or microcontrollers) each with suitable interfaces to the mechanism's sensors and actuators, and related embedded control software. The apparatus and methods of the present invention are usually under computer control, that is, with one or more embedded computers and an optional external supervisory computer. The embedded computers may be microprocessor- or microcontroller-type, configured with internal central processing units, program and data memory, analog-to-digital and digital-to-analog conversion interfaces, digital input and output (I/O) interfaces suitable for the control tasks required. These embedded computers are driven by custom embedded software specific to the control tasks and operation actions and methods described herein. The software programs provide for (i) sensing the power outputs of the power supply used by the electrical devices and/or sensing the current at the voice coil motor, (ii) determining whether one or more of the power outputs sensed are outside a predetermined range and/or whether the current sensed at the motor is outside a predetermined range, and (iii) causing the power supply to shut down entirely or to shut down certain of the power outputs if one or more of the power outputs are outside the predetermined range and/or the current at the motor is outside a predetermined range, and so forth. Such software may be written, preferably, in C++, C or in processor-specific assembly language.

An external supervisory computer may be, for example, an IBM® or Apple MacIntosh® compatible personal computer (PC). The external computer is driven by software specific to the methods described herein. A preferred computer hardware capable of assisting in the operation of the methods in accordance with the present invention involves a system with the following specifications: Pentium® processor or better with a clock speed of at least 200 MHz, at least 128 megabytes of random access memory at least 1 gigabyte disk mass storage, at least 10 megabit/sec Ethernet LAN interface, running a suitable operating system, either Windows NT 4.0 or Linux (or successors thereof). Supervisory computer software, that may be used to carry out the methods herein, may use C/C++, Visual BASIC, Visual C++, suitably extended via user-written functions and templates.

It should be understood that the above computer information and the software used herein are by way of example and not limitation. The present methods may be adapted to other embedded and supervisory computers, operating systems and runtime application-specific software.

Another aspect of the present invention is a computer program product comprising a computer readable storage medium having a computer program stored thereon which, when loaded into a computer, performs the aforementioned method.

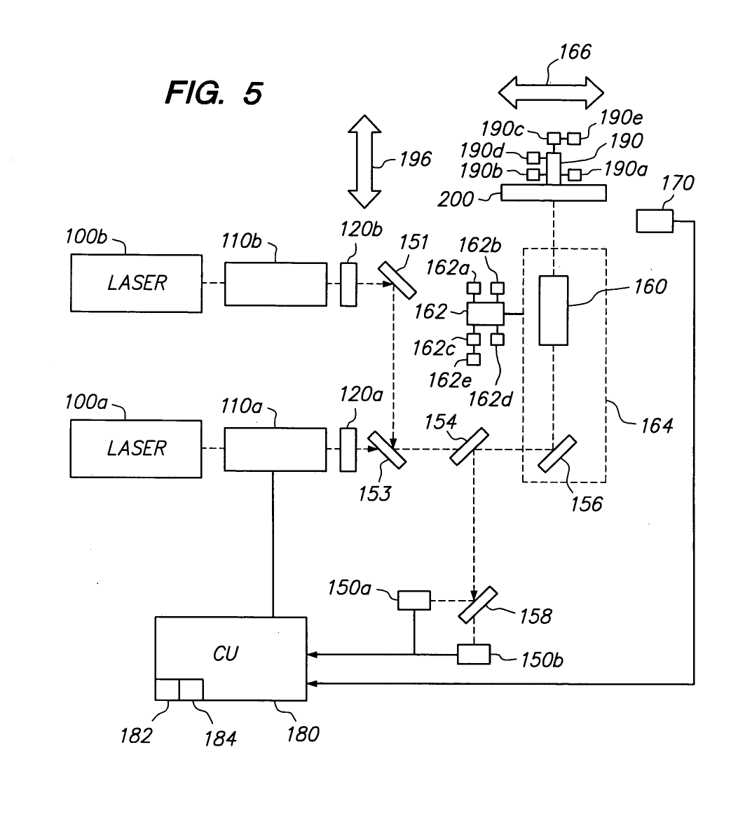

A specific embodiment in accordance with the present invention is described next by way of illustration and not limitation. Referring now to FIG. 5, an apparatus of the present invention (which may be generally referenced as an array “scanner”) is illustrated. A light system provides light from a laser 100, which passes through an electro-optic modulator (EOM) 110 with attached polarizer 120. Each laser 100a, 100b may be of different wavelength (for example, one providing red light and the other green) and each has its own corresponding EOM 110a, 110b and polarizer 120a, 120b. The beams may be combined along a path toward a holder 200 by the use of fold mirror 151 and dichroic mirror 153. A control signal in the form of a variable voltage applied to each corresponding EOM 110a, 110b by the controller (CU) 180, changes the polarization of the exiting light which is thus more or less attenuated by the corresponding polarizer 120a, 120b. Controller 180 may be or include a suitably programmed processor. Thus, each EOM 110 and corresponding polarizer 120 together act as a variable optical attenuator which can alter the power of an interrogating light spot exiting from the attenuator in a manner, and for purposes, such as described in U.S. Pat. No. 6,406,849. The remainder of the light from both lasers 100a, 100b is transmitted through a dichroic beam splitter 154, reflected off fully reflecting mirror 156 and focused onto either an array 12 (FIGS. 2-4) in an array package mounted on holder 200, or a calibration member, whichever is at a reading position, using optical components in beam focuser 190. Light emitted, in particular fluorescence, at two different wavelengths (for example, green and red light) from features 16, in response to the interrogating light, is imaged using the same optics in focuser/scanner 190/160, and is reflected off mirrors 156 and 154. The two different wavelengths are separated by a further dichroic mirror 158 and are passed to respective detectors 150a and 150b. More optical components (not shown) may be used between the dichroic and each detector 150a, 150b (such as lenses, pinholes, filters, fibers etc.) and each detector 150a, 150b may be of various different types (e.g. a photo-multiplier tube (PMT) or a CCD or an avalanche photodiode (APD)). All of the optical components through which light emitted from an array 12 in response to the illuminating laser light, passes to detectors 150a, 150b, together with those detectors, form a detection system. This detection system has a fixed focal plane.

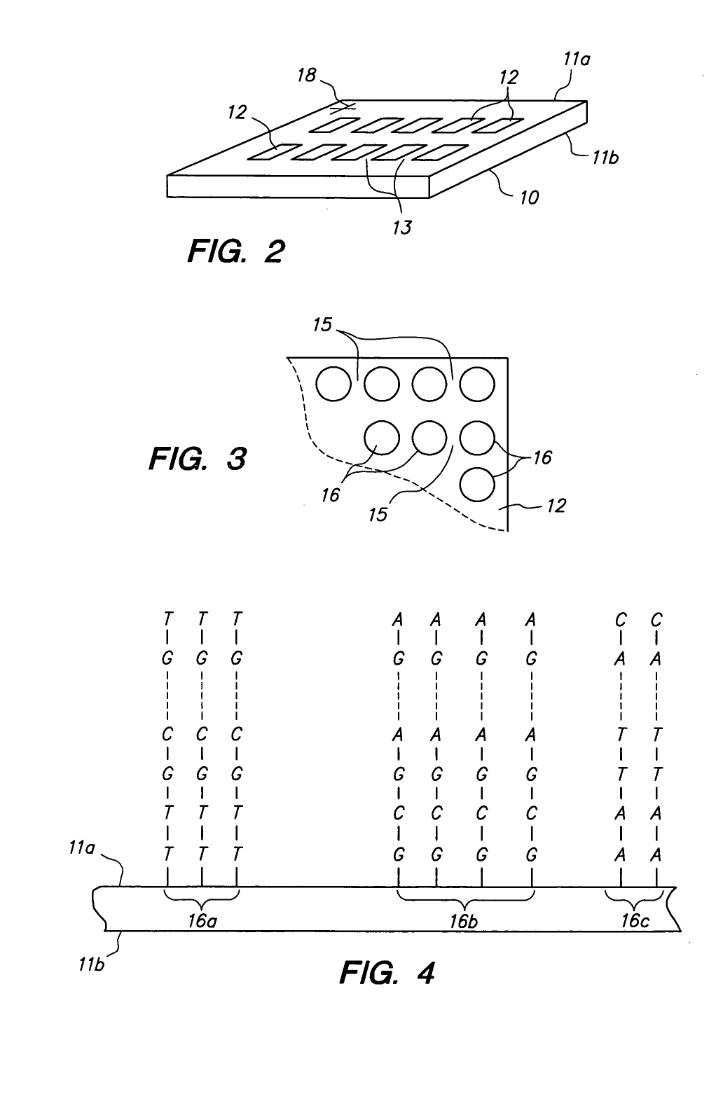

Referring to FIGS. 2-4, there is shown multiple identical arrays 12 (only some of which are shown in FIG. 2), separated by inter-array regions 13, across the complete front surface 11a of a single transparent substrate 10. However, the arrays 12 on a given substrate need not be identical and some or all could be different. Each array 12 will contain multiple spots or features 16 separated by inter-feature regions 15. A typical array 12 may contain from 100 to 100,000 features. At least some, or all, of the features are of different compositions (for example, when any repeats of each feature composition are excluded the remaining features may account for at least 5%, 10%, or 20% of the total number of features). Each feature carries a predetermined moiety (such as a particular polynucleotide sequence), or a predetermined mixture of moieties (such as a mixture of particular polynucleotides). This is illustrated schematically in FIG. 4 where different regions 16 are shown as carrying different polynucleotide sequences.

Substrates comprising polynucleotide arrays may be provided in a number of different formats. In one format, the array is provided as part of a package 30 in which the array itself is disposed on a first side of a glass or other transparent substrate. This substrate is fixed (such as by adhesive) to a housing with the array facing the interior of a chamber formed between the substrate and housing. An inlet and outlet may be provided to introduce and remove sample and wash liquids to and from the chamber during use of the array. The entire package may then be inserted into a laser scanner, and the sample-exposed array may be read through a second side of the substrate.

In another format, the array is present on an unmounted glass or other transparent slide substrate. This array is then exposed to a sample optionally using a temporary housing to form a chamber with the array substrate. The substrate may then be placed in a laser scanner to read the exposed array.

In another format the substrate is mounted on a substrate holder and retained thereon in a mounted position without the array contacting the holder. The holder is then inserted into an array reader and the array read. In one aspect of the above approach, the moieties may be on at least a portion of a rear surface of a transparent substrate, which is opposite a first portion on the front surface. In this format the substrate, when in the mounted position, has the exposed array facing a backer member of the holder without the array contacting the holder. The backer member is preferably has a very low in intrinsic fluorescence or is located far enough from the array to render any such fluorescence insignificant. Optionally, the array may be read through the front side of the substrate. The reading, for example, may include directing a light beam through the substrate from the front side and onto the array on the rear side. A resulting signal is detected from the array, which has passed from the rear side through the substrate and out the substrate front side. The holder may further include front and rear clamp sets, which can be moved apart to receive the substrate between the sets. In this case, the substrate is retained in the mounted position by the clamp sets being urged (such as resiliently, for example by one or more springs) against portions of the front and rear surfaces, respectively. The clamp sets may, for example, be urged against the substrate front and rear surfaces of a mounted substrate at positions adjacent a periphery of that slide. Alternatively, the array may be read on the front side when the substrate is positioned in the holder with the array facing forward (that is, away from the holder).

Referring again to FIG. 5, a scan system causes the illuminating region in the form of a light spot from each laser 100a, 100b, and a detecting region of each detector 150a, 150b (which detecting region will form a pixel in the detected image), to be scanned across multiple regions of an array package 30 mounted on holder 200. The scanned regions for an array 12 will include at least the multiple features 16 of the array. In particular the scanning system is a line by line scanner, scanning the interrogating light in a line across an array 12 when at the reading position, in a direction of arrow 166, then moving (“transitioning”) the interrogating light in a direction into/out of the paper as viewed in FIG. 5 to a position at an end of a next line, and repeating the line scanning and transitioning until the entire array 12 has been scanned. This can be accomplished by providing a housing 164 containing mirror 158 and focuser 160, which housing 164 can be moved along a line of pixels (that is, from left to right or the reverse as viewed in FIG. 7) by a transporter 162. Transporter 162 comprises power supply 162a, voice coil motor 162b, voice coil driver 162c and microcontroller 162d. Sense circuitry 162e resides at voice coil driver 162c.

The second transporter 190, which comprises power supply 190a, voice coil motor 190b, voice coil driver 190c, microcontroller 190d and sense circuitry 190e residing at voice coil driver 190c to move holder 200 into the focal plane. The apparatus of FIG. 5 may further include a reader (not shown), which reads an identifier from an array package 30. When identifier 40 is in the form of a bar code, such a reader may be a suitable bar code reader.

An autofocus detector 170 is also provided to sense any offset between different regions of array 12 when in the reading position, and a determined position of the focal plane of the detection system. An autofocus system includes detector 170, processor 180, and a motorized adjuster to move holder in the direction of arrow 196. A suitable chemical array autofocus system is described in U.S. Pat. No. 6,486,457 entitled “Apparatus And Method For Autofocus” by Dorsel, et al., the disclosure of which is incorporated herein by reference in its entirety.

Controller 180 of the apparatus is connected to receive signals from detectors 150a, 150b (these different signals being different “channels”), namely a signal which results at each of the multiple detected wavelengths from emitted light for each scanned region of array 12 when at the reading position mounted in holder 200. Controller 180 also receives the signal from autofocus offset detector 170 and provides the control signal to EOM 110, and controls the scan system. Controller 180 may also analyze, store, and/or output data relating to emitted signals received from detectors 150a, 150b in a known manner. Controller 180 may include a computer in the form of a programmable digital processor, and include a media reader 182 which can read a portable removable media (such as a magnetic or optical disk), and a communication module 184 which can communicate over a communication channel (such as a network, for example the internet or a telephone network) with a remote site (such as a database at which information relating to array package 30 may be stored in association with the identification 40). Controller 180 is suitably programmed to execute all of the steps required by it during operation of the apparatus, as discussed further below. Alternatively, controller 180 may be any hardware or hardware/software combination, which can execute those steps.

In one mode of operation, array 12 in suitable package is typically first exposed to a liquid sample (for example, placed directly on substrate 10 or introduced into a chamber through a septum). The array may then be washed and scanned with a liquid (such as a buffer solution) present in the chamber and in contact with the array, or it may be dried following washing. Following a given array package being mounted in the apparatus, the identifier reader may automatically (or upon operator command) read the array identifier (such as a bar code on the arrays substrate or housing), and use this to retrieve information on the array layout (including characteristics of the array features, such as size, location, and composition). Such information may be retrieved directly from the contents of the read identifier when the read identifier contains such information. Alternatively, the read identifier may be used to retrieve such information from a database containing the identifier in association with such information. Such a database may be a local database accessible by controller 180 (such as may be contained in a portable storage medium in drive 182 which is associated with the array, such as by physical association in a same package with the array when received by the user, or by a suitable identification), or may be a remote database accessible by controller 180 through communication module 184 and a suitable communication channel (not shown).

The invention has particular application to analyzing binding reactions between members of a specific binding pair. A member of a specific binding pair (“sbp member”) is one of two different molecules, having an area on the surface or in a cavity, which specifically binds to and is thereby defined as complementary with a particular spatial and polar organization of the other molecule. The members of the specific binding pair include ligand and receptor (antiligand). Specific binding pairs include members of an immunological pair such as antigen-antibody, biotin-avidin, hormones-hormone receptors, nucleic acid duplexes, IgG-protein A, polynucleotide pairs such as DNA-DNA, DNA-RNA, and the like.

As mentioned above, hybridization reactions between surface-bound probes and target molecules in solution may be used to detect the presence of particular biopolymers. Hybridization involves members of a specific binding pair that comprises polynucleotides. Hybridization is based on complementary base pairing. When complementary single stranded nucleic acids are incubated together, the complementary base sequences pair to form double stranded hybrid molecules. Following hybridization of the probe with the target nucleic acid, any oligonucleotide probe/nucleic acid hybrids that have formed are typically separated from unhybridized probe. The amount of oligonucleotide probe in either of the two separated media is then tested to provide a qualitative or quantitative measurement of the amount of target nucleic acid originally present.

In analyses procedures to which the present invention may be applied, one or more liquid samples are contacted with the surface of the substrate that comprises a plurality of chemical compounds. Contact may be achieved by methods well known in the art such as, for example, drop wise application of sample to individual features on the surface of the substrate, immersion of the substrate in the liquid samples, and so forth. The sample may be a trial sample, a reference sample, a combination of the foregoing, or a known mixture of components such as polynucleotides, proteins, polysaccharides and the like (in which case the arrays may be composed of features that are unknown such as polynucleotide sequences to be evaluated). The samples may be from biological assays such as in the identification of drug targets, single-nucleotide polymorphism mapping, monitoring samples from patients to track their response to treatment and/or assess the efficacy of new treatments, and so forth. For hybridization reactions the sample generally comprises a target molecule that may or may not hybridize to a surface-bound molecular probe. The term “target molecule” refers to a known or unknown molecule in a sample, which will hybridize to a molecular probe on a substrate surface if the target molecule and the molecular probe contain complementary regions. In general, the target molecule is a “biopolymer,” i.e., an oligomer or polymer. The present devices and methods have particular application to various processing steps involved with the aforementioned hybridization reactions.

An oligomer or polymer is a chemical entity that contains a plurality of monomers. It is generally accepted that the term “oligomers” is used to refer to a species of polymers. The terms “oligomer” and “polymer” may be used interchangeably herein. Polymers usually comprise at least two monomers. Oligomers generally comprise about 6 to about 20,000 monomers, preferably, about 10 to about 10,000, more preferably about 15 to about 4,000 monomers. Examples of polymers include polydeoxyribonucleotides, polyribonucleotides, other polynucleotides that are C-glycosides of a purine or pyrimidine base, or other modified polynucleotides, polypeptides, polysaccharides, and other chemical entities that contain repeating units of like chemical structure. Exemplary of oligomers are oligonucleotides and peptides.

A biomonomer refers to a single unit, which can be linked with the same or other biomonomers to form a biopolymer (for example, a single amino acid or nucleotide with two linking groups one or both of which may have removable protecting groups). A biomonomer fluid or biopolymer fluid refer to a liquid containing either a biomonomer or biopolymer, respectively (typically in solution).

A biopolymer is a polymer of one or more types of repeating units. Biopolymers are typically found in biological systems and particularly include polysaccharides (such as carbohydrates), and peptides (which term is used to include polypeptides, and proteins whether or not attached to a polysaccharide) and polynucleotides as well as their analogs such as those compounds composed of or containing amino acid analogs or non-amino acid groups, or nucleotide analogs or non-nucleotide groups. This includes polynucleotides in which the conventional backbone has been replaced with a non-naturally occurring or synthetic backbone, and nucleic acids (or synthetic or naturally occurring analogs) in which one or more of the conventional bases has been replaced with a group (natural or synthetic) capable of participating in Watson-Crick type hydrogen bonding interactions.

Polynucleotides are compounds or compositions that are polymeric nucleotides or nucleic acid polymers. The polynucleotide may be a natural compound or a synthetic compound. Polynucleotides include oligonucleotides and are comprised of natural nucleotides such as ribonucleotides and deoxyribonucleotides and their derivatives although unnatural nucleotide mimetics such as 2′-modified nucleosides, peptide nucleic acids and oligomeric nucleoside phosphonates are also used. The polynucleotide can have from about 2 to 5,000,000 or more nucleotides. Usually, the oligonucleotides are at least about 2 nucleotides, usually, about 5 to about 100 nucleotides, more usually, about 10 to about 50 nucleotides, and may be about 15 to about 30 nucleotides, in length. Polynucleotides include single or multiple stranded configurations, where one or more of the strands may or may not be completely aligned with another.

The polynucleotides include nucleic acids, and fragments thereof, from any source in purified or unpurified form including DNA (dsDNA and ssDNA) and RNA, including tRNA, mRNA, rRNA, mitochondrial DNA and RNA, chloroplast DNA and RNA, DNA/RNA hybrids, or mixtures thereof, genes, chromosomes, plasmids, cosmids, the genomes of biological material such as microorganisms, e.g., bacteria, yeasts, phage, chromosomes, viruses, viroids, molds, fungi, plants, animals, humans, and the like. The polynucleotide can be only a minor fraction of a complex mixture such as a biological sample. Also included are genes, such as hemoglobin gene for sickle-cell anemia, cystic fibrosis gene, oncogenes, cDNA, and the like. The polynucleotide can be obtained from various biological materials by procedures well known in the art. A target polynucleotide sequence is a sequence of nucleotides to be identified, detected or otherwise analyzed, usually existing within a portion or all of a polynucleotide.

A nucleotide refers to a sub-unit of a nucleic acid and has a phosphate group, a 5 carbon sugar and a nitrogen containing base, as well as functional analogs (whether synthetic or naturally occurring) of such sub-units which in the polymer form (as a polynucleotide) can hybridize with naturally occurring polynucleotides in a sequence specific manner analogous to that of two naturally occurring polynucleotides. For example, a “biopolymer” includes DNA (including cDNA), RNA, oligonucleotides, and PNA and other polynucleotides as described in U.S. Pat. No. 5,948,902 and references cited therein (all of which are incorporated herein by reference), regardless of the source. An “oligonucleotide” generally refers to a nucleotide multimer of about 10 to 100 nucleotides in length, while a “polynucleotide” includes a nucleotide multimer having any number of nucleotides.

The substrate to which a plurality of chemical compounds is attached is usually a porous or non-porous water insoluble material. The substrate can have any one of a number of shapes, such as strip, plate, disk, rod, particle, and the like. The substrate can be hydrophilic or capable of being rendered hydrophilic or it may be hydrophobic. The substrate is usually glass such as flat glass whose surface has been chemically activated to substrate binding or synthesis thereon, glass available as Bioglass and the like. However, the substrate may be made from materials such as inorganic powders, e.g., silica, magnesium sulfate, and alumina; natural polymeric materials, particularly cellulosic materials and materials derived from cellulose, such as fiber containing papers, e.g., filter paper, chromatographic paper, etc.; synthetic or modified naturally occurring polymers, such as nitrocellulose, cellulose acetate, poly (vinyl chloride), polyacrylamide, cross linked dextran, agarose, polyacrylate, polyethylene, polypropylene, poly(4-methylbutene), polystyrene, polymethacrylate, poly(ethylene terephthalate), nylon, poly(vinyl butyrate), etc.; either used by themselves or in conjunction with other materials; ceramics, metals, and the like. Preferably, for packaged arrays the substrate is a non-porous material such as glass, plastic, metal and the like.

The surface of the substrate, which comprises the chemical compounds, may be smooth or substantially planar, or have irregularities, such as depressions or elevations. The surface may be modified with one or more different layers of compounds that serve to modify the properties of the surface in a desirable manner such as, for example, rendering a portion or the entire surface hydrophilic or hydrophobic. The surface of a substrate is normally treated to create a primed or functionalized surface, that is, a surface that is able to support the synthetic steps involved in the production of arrays of the chemical compound.

The apparatus and methods of the present invention are particularly useful with substrates comprising an array or a plurality of arrays arranged on the surface of the substrate. An array includes any one, two- or three- dimensional arrangement of addressable regions bearing a particular biopolymer such as polynucleotides, associated with that region. An array is addressable in that it has multiple regions of different moieties, for example, different polynucleotide sequences, such that a region or feature or spot of the array at a particular predetermined location or address on the array can detect a particular target molecule or class of target molecules although a feature may incidentally detect non-target molecules of that feature. The one or more arrays disposed along a surface of the support are usually separated by inter-array areas. Normally, the surface of the support opposite the surface with the arrays does not carry any arrays.

The surface of the substrate may carry at least one, two, four, ten, up to thousands of arrays. Depending upon intended use, any or all of the arrays may be the same or different from one another and each may contain multiple spots or features of chemical compounds such as, e.g., biopolymers in the form of polynucleotides or other biopolymer. A typical array may contain more than ten, more than one hundred, more than one thousand, more than ten thousand features, or even more than one hundred thousand features, in an area of less than 20 cm² or even less than 10 cm². For example, features may have widths (that is, diameter, for a round spot) in the range from a 10 μm to 1.0 cm. In other embodiments each feature may have a width in the range of 1.0 μm to 1.0 mm, usually 5.0 μm to 500 μm, and more usually 10 μm to 200 μm. Non-round features may have area ranges equivalent to that of circular features with the foregoing width (diameter) ranges.

Each feature, or element, within the molecular array is defined to be a small, regularly shaped region of the surface of the substrate. The features are arranged in a predetermined manner. Each feature of an array usually carries a predetermined chemical compound or mixtures thereof. Each feature within the molecular array may contain a different molecular species, and the molecular species within a given feature may differ from the molecular species within the remaining features of the molecular array. Some or all of the features may be of different compositions. Each array may contain multiple spots or features and each array may be separated by spaces or areas. It will also be appreciated that there need not be any space separating arrays from one another. Interarray areas and interfeature areas are usually present but are not essential. These areas do not carry any chemical compound such as polynucleotide (or other biopolymer of a type of which the features are composed). Interarray areas and interfeature areas typically will be present where arrays are formed by the conventional in situ process or by deposition of previously obtained moieties. In one approach, arrays are synthesized by depositing for each feature at least one droplet of reagent such as from a pulse jet (for example, an inkjet type head) but may not be present when, for example, photolithographic array fabrication processes are used. It will be appreciated though, that the interarray areas and interfeature areas, when present, could be of various sizes and configurations.

The devices, apparatus and methods of the present invention are particularly applicable to substrates comprising oligonucleotide arrays and polynucleotide arrays for determinations of polynucleotides. As explained briefly above, in the field of bioscience, arrays of oligonucleotide or polynucleotide probes, fabricated or deposited on a surface of a substrate, are used to identify DNA sequences in cell matter. The arrays generally involve a surface containing a mosaic of different oligonucleotides or sample nucleic acid sequences or polynucleotides that are individually localized to discrete, known areas of the surface. In one approach, multiple identical arrays across a complete front surface of a single substrate or support are used. However, one or more of the arrays may be different from the other arrays on the substrate surface. Ordered arrays containing a large number of oligonucleotides have been developed as tools for high throughput analyses of genotype and gene expression. Oligonucleotides on a solid support surface recognize uniquely complementary nucleic acids by hybridization, and arrays can be designed to define specific target sequences, analyze gene expression patterns or identify specific allelic variations. The arrays may be used for conducting cell study, for diagnosing disease, identifying gene expression, monitoring drug response, determination of viral load, identifying genetic polymorphisms, analyze gene expression patterns or identify specific allelic variations, and the like.

An oligonucleotide probe may be, or may be capable of being, labeled with a reporter group, which generates a signal, or may be, or may be capable of becoming, bound to a support. Detection of signal depends upon the nature of the label or reporter group. Commonly, binding of an oligonucleotide probe to a target polynucleotide sequence is detected by means of a label incorporated into the target. Alternatively, the target polynucleotide sequence may be unlabeled and a second oligonucleotide probe may be labeled. Binding can be detected by separating the bound second oligonucleotide probe or target polynucleotide from the free second oligonucleotide probe or target polynucleotide and detecting the label. In one approach, a sandwich is formed comprised of one oligonucleotide probe, which may be labeled, the target polynucleotide and an oligonucleotide probe that is or can become bound to a surface of a support. Alternatively, binding can be detected by a change in the signal-producing properties of the label upon binding, such as a change in the emission efficiency of a fluorescent or chemiluminescent label. This permits detection to be carried out without a separation step. Finally, binding can be detected by labeling the target polynucleotide, allowing the target polynucleotide to hybridize to a surface-bound oligonucleotide probe, washing away the unbound target polynucleotide and detecting the labeled target polynucleotide that remains. Direct detection of labeled target polynucleotide hybridized to surface-bound oligonucleotide probes is particularly advantageous in the use of ordered arrays.

The signal referred to above may arise from any moiety that may be incorporated into a molecule such as an oligonucleotide probe for the purpose of detection. Often, a label is employed, which may be a member of a signal producing system. The label is capable of being detected directly or indirectly. In general, any reporter molecule that is detectable can be a label. Labels include, for example, (i) reporter molecules that can be detected directly by virtue of generating a signal, (ii) specific binding pair members that may be detected indirectly by subsequent binding to a cognate that contains a reporter molecule, (iii) mass tags detectable by mass spectrometry, (iv) oligonucleotide primers that can provide a template for amplification or ligation and (v) a specific polynucleotide sequence or recognition sequence that can act as a ligand such as for a repressor protein, wherein in the latter two instances the oligonucleotide primer or repressor protein will have, or be capable of having, a reporter molecule and so forth. The reporter molecule can be a catalyst, such as an enzyme, a polynucleotide coding for a catalyst, promoter, dye, fluorescent molecule, chemiluminescent molecule, coenzyme, enzyme substrate, radioactive group, a small organic molecule, amplifiable polynucleotide sequence, a particle such as latex or carbon particle, metal sol, crystallite, liposome, cell, etc., which may or may not be further labeled with a dye, catalyst or other detectable group, a mass tag that alters the weight of the molecule to which it is conjugated for mass spectrometry purposes, and the like.

The signal may be produced by a signal producing system, which is a system that generates a signal that relates to the presence or amount of a target polynucleotide in a medium. The signal producing system may have one or more components, at least one component being the label. The signal producing system includes all of the reagents required to produce a measurable signal. The signal producing system provides a signal detectable by external means, by use of electromagnetic radiation, desirably by visual examination. Signal-producing systems that may be employed in the present invention are those described more fully in U.S. Pat. No. 5,508,178, the relevant disclosure of which is incorporated herein by reference.

The arrays and the liquid samples are maintained in contact for a period of time sufficient for the desired chemical reaction to occur. The conditions for a reaction, such as, for example, period of time of contact, temperature, pH, salt concentration and so forth, are dependent on the nature of the chemical reaction, the nature of the chemical reactants including the liquid samples, and the like. The conditions for binding of members of specific binding pairs are generally well known and will not be discussed in detail here. The conditions for the various processing steps are also known in the art.

As mentioned above, the present apparatus and methods are particularly suitable for conducting hybridization reactions. Such reactions are carried out on a substrate or support comprising a plurality of features relating to the hybridization reactions. The substrate is exposed to liquid samples and to other reagents for carrying out the hybridization reactions. The support surface exposed to the sample is incubated under conditions suitable for hybridization reactions to occur.

After the appropriate period of time of contact between the liquid samples in the wells and the arrays on the surface of the substrate, the contact is discontinued and various processing steps are performed. The amount of the fluid reagents employed in each processing step in the method of the present invention is dependent on the nature of the reagents and the size of the housing chamber. Such amounts should be readily apparent to those skilled in the art in view of the disclosure herein. Typically, the amounts of the fluid reagents are those necessary to successfully accomplish the particular processing step. The time period for contact of the fluid reagents and the substrate is dependent upon the specific reaction and fluid reagents being utilized.

Following the processing of the substrate, it is moved to an interrogating device where the surface of the substrate on which the arrays are disposed is interrogated. In accordance with the present invention, the interrogating device is an apparatus as described above. Reading of the array may be accomplished by illuminating the array and reading the location and intensity of resulting fluorescence at each feature of the array.

Results from the reading may be raw results (such as fluorescence intensity readings for each feature in one or more color channels) or may be processed results such as obtained by rejecting a reading for a feature that is below a predetermined threshold and/or forming conclusions based on the pattern read from the array (such as whether or not a particular target sequence may have been present in the sample). The results of the reading (processed or not) may be forwarded (such as by communication) to a remote location if desired, and received there for further use (such as further processing).

One aspect of the invention is the product of the above method, namely, the assay result, which may be evaluated at the site of the testing or it may be shipped to another site for evaluation and communication to an interested party at a remote location if desired. By the term “remote location” is meant a location that is physically different than that at which the results are obtained. Accordingly, the results may be sent to a different room, a different building, a different part of city, a different city, and so forth. Usually, the remote location is at least about one mile, usually, at least ten miles, more usually about a hundred miles, or more from the location at which the results are obtained. The data may be transmitted by standard means such as, e.g., facsimile, mail, overnight delivery, e-mail, voice mail, and the like.

“Communicating” information references transmitting the data representing that information as electrical signals over a suitable communication channel (for example, a private or public network). “Forwarding” an item refers to any means of getting that item from one location to the next, whether by physically transporting that item or otherwise (where that is possible) and includes, at least in the case of data, physically transporting a medium carrying the data or communicating the data.

All publications and patent applications cited in this specification are herein incorporated by reference as if each individual publication or patent application were specifically and individually indicated to be incorporated by reference, except insofar as they may conflict with those of the present application (in which case the present application prevails). Methods recited herein may be carried out in any order of the recited events, which is logically possible, as well as the recited order of events.

Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the appended claims. Furthermore, the foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description; they are not intended to be exhaustive or to limit the invention to the precise forms disclosed. Many modifications and variations are possible in view of the above teachings. The embodiments were chosen and described in order to explain the principles of the invention and its practical applications and to thereby enable others skilled in the art to utilize the invention.

1. An apparatus for interrogating the surface of a substrate comprising a plurality of features, said apparatus comprising:
(a) a source of light,
(b) a holder for a substrate,
(c) a linear actuator motor with a driver for moving said holder with respect to said source of light,
(d) a power supply for the linear actuator motor and driver, and
(e) circuitry that disables one or more outputs of said power supply.

2. An apparatus according to claim 1 wherein said circuitry disables all power outputs of said power supply.

3. An apparatus according to claim 1 wherein said circuitry disables less than all power outputs of said power supply.

4. An apparatus according to claim 3 wherein said circuitry disables the power outputs of said power supply to said driver.

5. An apparatus according to claim 1 wherein said circuitry comprises sense circuitry that detects failure of power outputs of said power supply

6. An apparatus according to claim 1 wherein said circuitry comprises sense circuitry that detects energy at said motor or said driver.

7. An apparatus according to claim 1 wherein said linear actuator motor is a voice coil motor and said driver is a voice coil driver.

8. An apparatus according to claim 1 wherein said circuitry comprises sense circuitry comprising a detection circuit to determine if the sense circuitry is connected to disable circuitry of the power supply.

9. An apparatus according to claim 8 wherein said detection circuit determines the supply voltage less the forward drop across an LED of the disable circuitry.

10. An apparatus according to claim 8 wherein said sense circuitry comprises detection circuit for indicating inability of the sense circuitry to function.

11. An apparatus according to claim 10 wherein said detection circuit intercepts an enable signal for the driver.

12. An apparatus according to claim 1 wherein a disable signal from the power supply causes the power supply to shut down entirely or to shut down one or more of the power outputs.

13. An apparatus according to claim 1 wherein said circuitry comprises sense circuitry that resides at the driver

14. A method for reducing damage to a linear actuator motor, or a linear actuator motor and a driver therefor, powered by a power supply, said method comprising disabling one or more power outputs of said power supply.

15. A method according to claim 14 comprising disabling all power outputs of said power supply.

16. A method according to claim 14 comprising disabling less than all power outputs of said power supply.

17. A method according to claim 16 wherein comprising disabling the power outputs of said power supply to said driver.

18. A method according to claim 14 comprising sensing an energy level at the voice coil driver above a predetermined level prior to said disabling.

19. A method according to claim 14 comprising sensing a failure of one or more power outputs of the power supply prior to said disabling.

20. A method for reducing damage to components in a voice coil motor and a voice coil driver powered by a power supply, said method comprising:
(a) determining a failure of one or more of the power outputs of the power supply used by the voice coil motor and the voice coil driver and/or determining energy in the voice coil motor outside a predetermined range and
(b) causing the power supply to shut down entirely or to shut down less than all of the power outputs of said power supply if a failure is determined and/or if energy outside a predetermined range is determined.

21. A method according to claim 20 wherein said failure and/or said energy is determined by sense circuitry residing at the driver.

22. A method according to claim 21 wherein said sense circuitry comprises a detection circuit to determine if the sense circuitry is connected to disable circuitry of the power supply.

23. A method according to claim 22 wherein said detection circuit determines the supply voltage less the forward drop across an LED of the disable circuitry.

24. A method according to claim 21 wherein said sense circuitry comprises a detection circuit for indicating inability of the sense circuitry to function.

25. A method according to claim 24 wherein said detection circuit intercepts an enable signal for the driver.

26. A method according to claim 20 wherein a power supply disable signal is employed to cause the power supply to shut down entirely or to shut down less than all of the power outputs.

27. A method according to claim 20 wherein the power supply, the voice coil and the driver are part of a microarray interrogation apparatus.

28. A method for reducing thermal damage to electrical devices associated with moving components relative to one another wherein the electrical devices comprise a motor and a driver and are powered by a power supply, said method comprising:
(a) sensing the power outputs of the power supply used by the electrical devices and/or the current at the motor or the driver,
(b) determining whether one or more of the power outputs sensed in (a) are outside a predetermined range and/or whether the current at the motor or the driver sensed in (a) is outside a predetermined range, and
(c) causing the power supply to shut down entirely or to shut down less than all of the power outputs if one or more of the power outputs are outside the predetermined range and/or if the current at the motor or driver is outside a predetermined range.

29. A method according to claim 28 wherein said components comprise a voice coil motor and a voice coil driver and said method comprises:
(a) sensing the power outputs of the power supply used by the voice coil motor and the voice coil driver,
(b) determining whether one or more of the power outputs sensed in (a) are outside a predetermined range, and
(c) causing the power supply to shut down entirely or to shut down the power outputs if one or more of the power outputs are outside the predetermined range.

30. A method according to claim 28 wherein said sensing is carried out by sense circuitry residing at the driver.

31. A method according to claim 30 wherein said sensing comprises determining if the sense circuitry is connected to disable circuitry of the power supply.

32. A method according to claim 28 wherein said sensing comprises determining the supply voltage less the forward drop across an LED of disable circuitry of said power supply.

33. A method according to claim 30 wherein said sensing comprises a detection circuit for indicating inability of said sense circuitry to function.

34. A method according to claim 33 comprising intercepting an enable signal for the driver.

35. A method according to claim 28 comprising employing a power supply disable signal to cause the power supply to shut down entirely or to shut down less than all of the power outputs.

36. A method according to claim 28 wherein the power supply and the components are part of a microarray interrogation apparatus.

37. A method according to claim 28 wherein said components comprise a voice coil motor and a voice coil driver and said method comprises:
(a) sensing the current at the voice coil motor or the voice coil driver,
(b) determining whether the current sensed in (a) is outside a predetermined range, and
(c) causing the power supply to shut down entirely or to shut down the power outputs if the current is outside the predetermined range.
